(19) United States
(12) Patent Application Publication
(10) Pub. No.: US 2006/0227102 A1
(43) Pub. Date: Oct. 12, 2006

(54) Multi-function electronic device

(76) Inventors: Andrea Finke-Anlauff, Braunschweig (DE); Torsten Gunther, Braunschweig (DE); Lutz Cordes, Hannover (DE)

Correspondence Address: Ralph D. Gelling;Perman & Green, LLP, 425 Post Road, Fairfield, CT, 06824, US

(21) Appl. No.: 11/104,380

(22) Filed: Apr. 12, 2005

(51) Int. Cl. G09G 5/00

(52) U.S. Cl. 345/156

(57) ABSTRACT

A multi-function electronic device, includes a cover mounted on a body for pivotal motion from a closed position to an open position. The cover is transparent. A keyboard is mounted on the cover and a display is mounted on the body for viewing through the cover in operative relation with the keyboard.

### BACKGROUND OF THE INVENTION

1. Field of the Invention

The subject matter of this application relates to an arrangement of components that combines the functions of a multi-use electronic device to optimize their usefulness. More specifically, this application describes an electronic device having a display and a movable, transparent, protective panel for covering the display.

2. Brief Description of Related Developments

Mobile telephones and similar communication devices now provide a multitude of services, such as, Internet access, personal information management, facsimile, text messaging, picture, video, radio, in addition to telephone communication. This requires an arrangement of the components in a package that allows the efficient and ergonomically convenient use of the various functions.

With the introduction of such multi-function electronic devices, it has become increasingly more difficult to design a user interface that enables the user to access the many types of functions and applications available in small hand held devices. It is a particular challenge to present a simple and efficient means by which the user can communicate with the device for browsing, selecting, and operating amidst the wide array of functional choices. The user interface generally consists of a keypad for entering data and commands and a display screen for presenting information relating to operation of the selected function. The keypad and display are in continuous competition for space on the device, as it is desirable that each be as large as possible for ease of use and viewing. This is particularly difficult when it is advantageous to provide a full function keyboard, for example, a QWERTY style keyboard.

U.S. Pat. No. 6,757,157 is an example of a device that shows a two panel construction in which the two panels are moveable with respect to each other by means of an interconnecting hinge. The hinge is constructed to permit a full range of 360° relative movement between the panels. The disclosure of the '157 is incorporated herein in its entirety by reference.

Hinges, especially adapted for use in providing relative movement between two panels of a mobile communication device, are described in commonly owned, U.S. patent application Ser. No. 10/829415, filed Apr. 21, 2004 and Ser. No. 10/421278, filed Apr. 23, 2003. The disclosures of these applications are incorporated herein by reference in their entirety. Hinges of the type described in these applications would be adaptable to provide the relative motion of the parts of the device of this invention.

It is a purpose of this invention to use a fully rotatable cover panel to maximize the allotment of space to a display and a keyboard.

### SUMMARY OF THE INVENTION

A multi-function electronic device, such as a combination PDA/cellular telephone is designed to provide a wide variety of functions including, at least, a personal digital assistant, and a cellular telephone. The device consists of a body and a cover, attached for relative movement by a hinge. The hinge may provide a range of movement for the cover of a full 360°. A microprocessor controller correlates particular functions to preselected cover positions.

The body portion is constructed as a housing that encloses the components of the device in various known configurations to provide a wide variety of functions and applications. These components include, for example a microprocessor, mobile telephone transceiver, PDA, display driver firmware, display memory and other processor components depending on the features offered to the user.

In accordance with one aspect of the invention, a display screen is arranged on the top surface of the body and the substantially rectangular shape of the display extends over a majority of the area of the top surface. A cover is attached to the body by hinges for pivoting motion about an axis that allows the cover panel to be moved from a first position in which it covers the top surface of the body and a second position in which the cover panel is out of the way at the bottom surface of the body. The cover panel is transparent to allow at least a portion of the display screen to be visible at all times. A keyboard is provided on the cover panel for use in conjunction with the visible portion of the display screen.

In accordance with another aspect of the invention the keyboard contains a full QWERTY array of keys and the array is arranged in alignment with the length of the rectangular display screen to maximize its size.

In accordance with another aspect of the invention the display screen is touch sensitive.

In accordance with another aspect of the invention the cover panel is mounted on the body for sliding motion thereon from a covered position to a position in which the display is fully uncovered. This sliding motion could be either parallel or transverse to the longitudinal axis. In addition a combined sliding a pivotal motion could be employed.

### BRIEF DESCRIPTION OF THE DRAWINGS

The device of this invention is explained in more detail below with reference to the accompanying drawings, in which:

FIG. 1 is a perspective view of an embodiment of a multi-function device with the cover panel in a closed position;

FIG. 2 is a perspective view of the multi-function device shown in FIG. 1 with the cover panel moved to a 180° open position;

FIG. 3 is a perspective view of the multi-function device shown in FIG. 1 with cover panel moved to approximately 270° open position;

FIG. 4 is a perspective view of the multi-function device of FIG. 1 with the cover panel rotated 360°.

FIG. 5 is a block diagram of one embodiment of a PDA/cellphone according to this invention;

FIG. 6 is a perspective view of the multi-function device of FIG. 1 with the cover movable by a sliding motion parallel to the longitudinal axis.

FIG. 7 is a perspective view of the multi-function device of FIG. 1 with the cover movable by a sliding motion transverse to the longitudinal axis.

### DESCRIPTION OF PREFERRED EMBODIMENTS

A multifunctional device 10, for example a combination PDA and cellular telephone incorporating features of the present invention is illustrated in the figures. Although the present invention will be described with reference to the embodiments shown in the drawings, it should be understood that the present invention may have many alternate forms. In addition, any suitable size, shape or type of elements or materials could be used.

Multi-function electronic device 10, may be designed to provide a wide variety of functions including, personal digital assistant, Internet access, cellular telephone, digital camera, clock, radio, and others. For the purposes of describing the subject invention, only the PDA and cellular functions are discussed, but it is intended that the arrangement described herein may be used with many other functions and services.

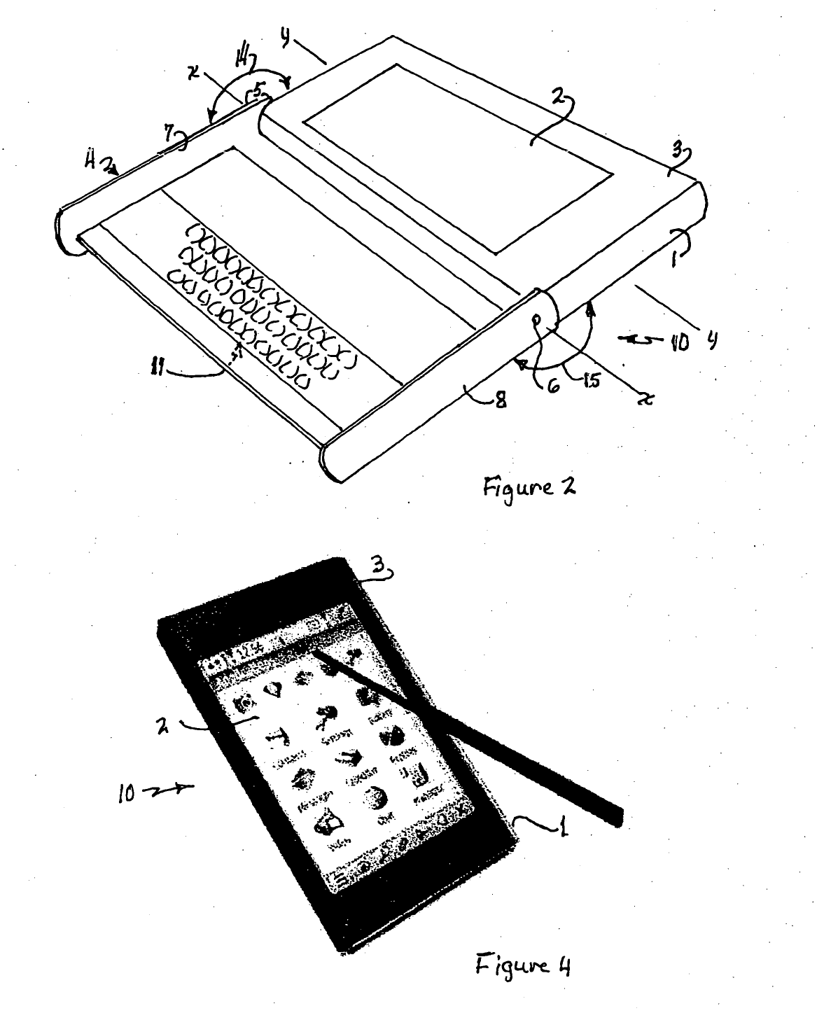

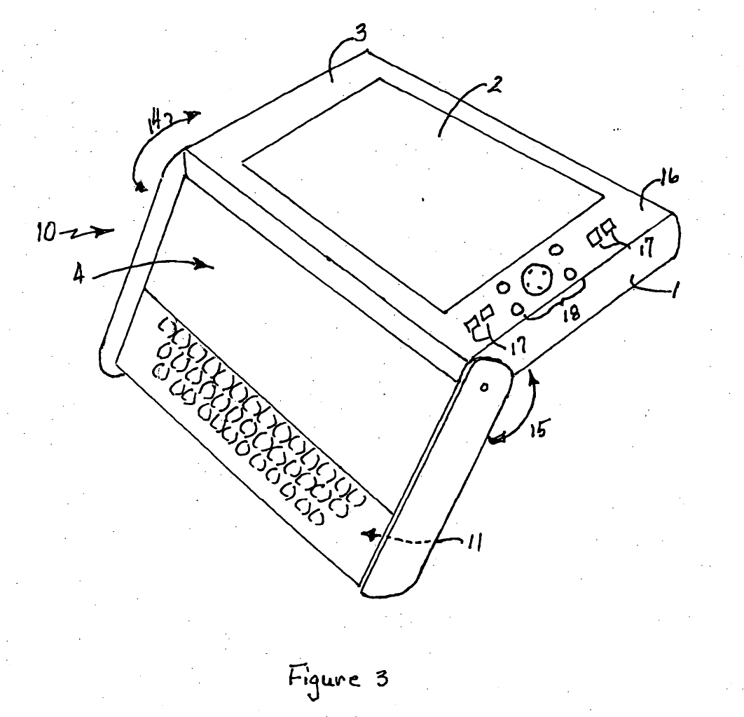

As shown in FIG. 2, device 10 is constructed with a body 1 that provides a housing for the components of the device 10 and has a longitudinal axis y-y. A display screen 2 is mounted on the top surface 3 of body 10 and is dimensioned to maximize its size relative to surface 3. A cover module 4 is pivotally attached to body 1 by hinges 5 and 6. Hinges 5 and 6 allow the complete rotation of cover module 4 about axis x-x so that cover module 4 is capable of being folded into a stored position below body 1, as shown by arrows 14 and 15.

Body 1 is of generally rectangular shape and display 2 is mounted thereon in operating connection with the components of the device 10 contained within body 1. The display is arranged on body 1 to maximize its size. As shown, it has a rectangular display area, substantially coextensive with the top surface 3 of body 1. In one embodiment of this invention, display screen 2 is a touch sensitive display adapted to provide operating functions, for example menu selection, Internet browsing, communications and other functions. In another embodiment of this invention a side deck 16 may be constructed on top surface 3 of body 1 to allow the mounting of additional function keys 17 and operational buttons 18.

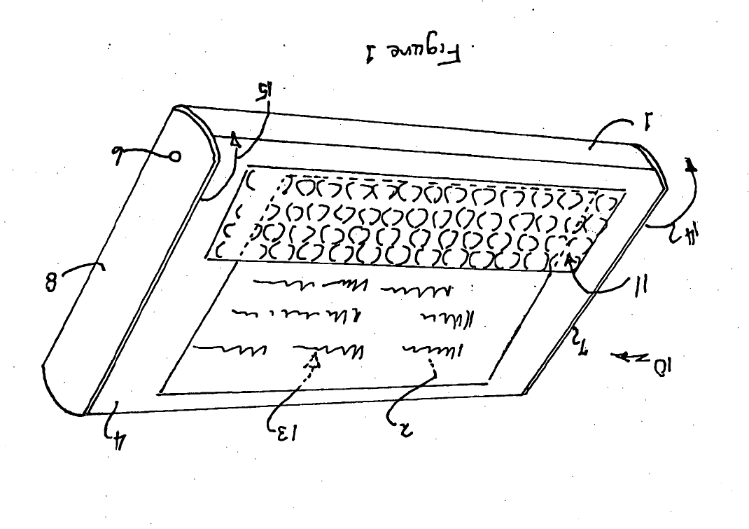

Cover module 4 is constructed with side panels 7 and 8 a flat transparent cover panel 9 mounted between side panels 7 and 8. Cover panel 9 is positioned on side panels 7 and 8 to fit over body 1 in a snug fit in the closed position of FIG. 1. This provides a secure platform for use of the keyboard 11 which is constructed in cover panel 9. Cover panel 9 is constructed of a transparent material to allow the display screen 2 to be viewed when covered by cover module 4.

In a preferred embodiment of this invention, keyboard 11 is a full function text keyboard, such as a Qwerty style keyboard connected through hinges 5 and 6 to the components of device 10 in body 1. Keyboard 11 is positioned parallel to longitudinal axis y-y of body 1 to allow the keys to be spread as widely as possible for convenient use.

In an alternate embodiment, the pivot support could be positioned to allow motion about an axis transverse to the longitudinal axis y-y. In this configuration, the keyboard 11 would still be position parallel to the longitudinal axis y.

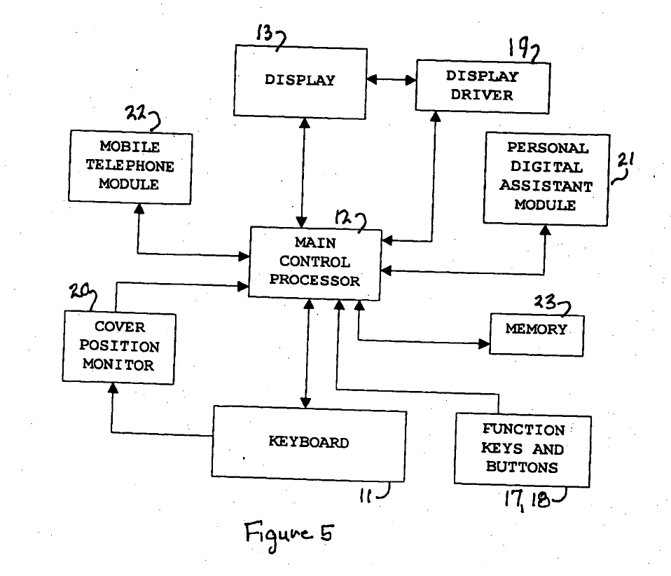

In operation, as shown in FIG. 5, a controller 12 coordinates the operation of the keyboard 11 with the display screen 2. A display driver 19 operatively associated with display screen 2 causes the data display 13 to be oriented longitudinally on the display screen 2, parallel with the keyboard 11. A cover position monitor 20 provides a signal indicative of the position of the cover to prompt the controller 12 to activate the keyboard 11 in the closed position and, if the keyboard is not to be used, to deactivate keyboard 11 in the stored position. In an alternate embodiment, the keyboard may be arranged for use in the stored position. To provide an accessible keyboard in the stored position the surface 11a, exposed in the stored position, would be touch sensitive.

In an embodiment of the invention a PDA module 21 is operatively associated with display screen 2 and keyboard 11 through controller 12. Similarly a cellular phone module 22 operates through controller 12. A memory 23 may be provided to store data and programs for executing the various function provided by the device 10. These components such as controller 12, display driver 19, telephone module 22, PDA module 21, memory 23, may all be enclosed within body

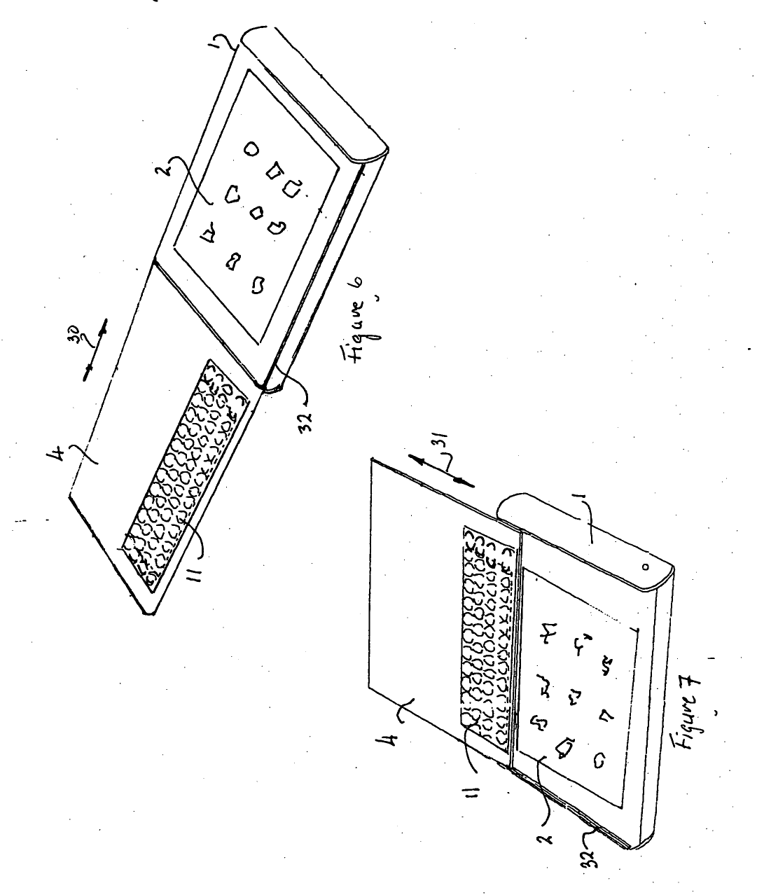

As shown in the alternate embodiments of FIGS. 5 and 6, the cover panel 4 may be mounted on the body 1 for sliding motion thereon, as shown by arrow 30. This motion could be accomplished by mounting the cover panel on grooves 32 constructed on body 1. In this embodiment the cover panel 4 may be moved from a covered position to a position in which the display is fully uncovered. This sliding motion could be either parallel, as shown in FIG. 5, (arrow 30) or transverse, as shown in FIG. 6, (arrow 31) to the longitudinal axis y-y of the device. In addition a combined sliding a pivotal motion could be employed. A panel having a combined sliding and pivotal motion adaptable to this purpose is shown in commonly owned, U.S. Pat. No. 6,850,226, issued Feb. 1, 2005.

It should be understood that the above description is only illustrative of the invention. Various alternatives and modifications can be devised by those skilled in the art with out departing from the invention. Accordingly, the present invention is intended to embrace all such alternatives, modifications and variances which fall with the scope of the appended claims.

What is claimed is:

1. An electronic device for use in multiple applications comprising:
a body having top and bottom surfaces, said body adapted to enclose a plurality of electronic components arranged within the body to provide multiple functions selectable by a user;
a display screen mounted on the top surface of the body to display data and images in operational association with the plurality of electronic components;
a cover connected to the body by means of hinges, said hinges constructed to allow the relative pivotal movement of said cover on said body from a first position covering the display to a second position at which the display is fully uncovered, and wherein said cover is transparent; and
a keyboard mounted on the cover in operative association with said display and at least some of the plurality of components, to allow the input and display of data and images.

2. An electronic device for use in multiple applications, according to claim 1, wherein the display screen is arranged to be substantially coextensive with the top surface of the body to maximize the potential area on which data and images can be displayed.

3. An electronic device for use in multiple applications, according to claim 1, wherein the display screen is touch sensitive.

4. An electronic device for use in multiple applications, according to claim 1, further comprising a controller adapted to coordinate the operation of the display with the operation of the keyboard such that the data and images displayed are oriented in parallel relation to the keyboard when the keyboard is in use.

5. An electronic device for use in multiple applications, according to claim 1, wherein the body has a longitudinal axis and the cover has an axis of motion that is transverse to said longitudinal axis and further wherein the keyboard is arranged on the cover in a parallel relation to said longitudinal axis.

6. An electronic device for use in multiple applications, according to claim 1, wherein the body has a longitudinal axis and the cover has an axis of motion that is parallel to said longitudinal axis and further wherein the keyboard is arranged on the cover in a parallel relation to said longitudinal axis.

7. An electronic device for use in multiple applications, according to claim 6, wherein at least a portion of the display is visible through said cover, when the cover is in the operational position, and further wherein a controller is adapted to coordinate the operation of the display with the operation of the keyboard, such that the data and images displayed are oriented in parallel relation to the keyboard and limited to said at least a portion of the display visible through the transparent cover.

8. An electronic device for use in multiple applications, according to claim 1, wherein the keyboard comprises a full function QWERTY array of keys.

9. An electronic device for use in multiple applications, according to claim 1, wherein the cover is attached to the body by a slide means that allows the cover to be moved from a position covering the display to a position at which the display is fully uncovered.

10. An electronic device for use in multiple applications, according to claim 1, wherein the cover may be pivoted 360 degrees.

11. An electronic device for use in multiple applications, according to claim 1, wherein the cover is attached to the body by means that provide a combination of sliding motion and pivotal motion that allows the cover to be moved from a first position covering the display to a second position at which the display is fully uncovered.

12. An electronic device for use in multiple applications, according to claim 10, wherein the keyboard is operable in the 360 degree position.
